(19) United States
(12) Patent Application Publication
(10) Pub. No.: US 2025/0333318 A1
(43) Pub. Date: Oct. 30, 2025

(54) METHOD FOR PRODUCING LITHIUM DIFLUOROPHOSPHATE

(71) Applicant: ECOPROHN CO., LTD., Chungcheongbuk-do (KR)

(72) Inventors: JONG WON JEON, Chungcheongbuk-do (KR); DA YOUNG MIN, Chungcheongbuk-do (KR); GANG SAN KIM, Chungcheongbuk-do (KR)

(21) Appl. No.: 18/864,622

(22) PCT Filed: Jun. 8, 2023
(86) PCT No.: PCT/KR2023/007832

§ 371 Date: Nov. 11, 2024

(30) Foreign Application Priority Data
Jun. 15, 2022 (KR) 10-2022-0072991

(51) Int. Cl. C01D 15/00

(52) U.S. Cl. CPC C01D 15/00; C01P 2002/82; C01P 2002/86

(57) ABSTRACT

A method for producing lithium difluorophosphate includes reacting a fluorine source and a phosphoryl halide represented by Formula 1 in a first organic solvent to obtain a reaction product and reacting the reaction product, a lithium source, and an oxygen source in a second organic solvent. Each of the fluorine source, the lithium source and the oxygen source may have a moisture content of less than 1,000 ppm based on the weight thereof.

### BACKGROUND

### 1. Technical Field

The present invention relates to a method for producing lithium difluorophosphate.

### 2. Background Art

Recently, a lithium secondary battery is widely used as a power source for an electronic device such as a mobile phone or laptop computer, or an electric vehicle or power storage device.

In particular, as the lithium secondary battery is applied to the electric vehicle, development of a lithium secondary battery having high capacity and high output characteristics is required.

For example, the lithium secondary battery may include: a cathode including a cathode active material containing a material capable of intercalating and deintercalating lithium ions; an anode including a material capable of intercalating and deintercalating lithium ions; and a non-aqueous electrolyte including a lithium salt and a non-aqueous solvent.

For example, as the cathode active material, lithium metal oxides such as LiCoO₂, LiMnO₂, LiNiO₂, LiFePO₄, LiNiₐCo_{b}Al_{c}O₂ (a+b+c=1), LiNiₐCo_{b}Mn_{c}CO₂ (a+b+c=1), etc. may be used.

In addition, as the anode active material, metal lithium, a metal compound (a metallic monomer, oxide, alloy with lithium, etc.) or carbon material may be used. In particular, a graphite-based material such as artificial graphite and natural graphite is mainly used.

For example, as the non-aqueous electrolyte, an electrolyte prepared by dissolving a lithium salt such as LiPF₆ or LiBF₄ in a mixed solvent (non-aqueous solvent) of carbonates such as ethylene carbonate, propylene carbonate, dimethyl carbonate, and ethyl methyl carbonate may be used.

Meanwhile, in order to improve the performance (e.g., life-span characteristics, high-temperature storage characteristics, etc.) of the lithium secondary battery, a technique for containing a predetermined additive in the non-aqueous electrolyte has been proposed.

For example, in order to improve the high-temperature storage characteristics of the lithium secondary battery, a technique for using lithium difluorophosphate as an additive is known in the art.

In addition, a method for producing the lithium difluorophosphate is known in the art. For example, Korean Patent Publication Nos. 10-1739936 and 10-1898803 disclose a method for producing lithium difluorophosphate using LiPF₆, water and the like.

### SUMMARY

An object of the present invention is to provide a method for producing lithium difluorophosphate, which may prepare lithium difluorophosphate with high yield and high purity.

To achieve the above object, a method for producing lithium difluorophosphate according to exemplary embodiments of the present invention may include the steps of: (S1) reacting a fluorine source and a phosphoryl halide represented by Formula 1 below in a first organic solvent; and (S2) reacting the reaction product in step S1, a lithium source and an oxygen source in a second organic solvent. Each of the fluorine source, the lithium source and the oxygen source may have a moisture content of less than 1,000 ppm based on the weight thereof:

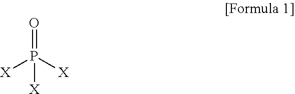

In Formula 1, X may be Cl, Br or I.

In one embodiment, the fluorine source may have a moisture content of less than 100 ppm based on the weight thereof.

In one embodiment, each of the lithium source and the oxygen source may have a moisture content of less than 700 ppm based on the weight thereof.

In one embodiment, the fluorine source may include at least one of hydrogen fluoride (HF), sodium fluoride (NaF), potassium fluoride (KF) and ammonium fluoride (NH₄F).

In one embodiment, in Formula 1, X may be Cl.

In one embodiment, lithium hydroxide (LiOH) or lithium carbonate (Li₂CO₃) may be used as the lithium source and the oxygen source.

In one embodiment, each of the first organic solvent and the second organic solvent may include a polar aprotic organic solvent.

In one embodiment, the first organic solvent and the second organic solvent may be the same as each other, and may include at least one of ethyl acetate (EA), ethylene dichloride (EDC) and dimethyl ether (DME).

In one embodiment, step S1 may include mixing the phosphoryl halide and the fluorine source so that a molar ratio of fluorine to the phosphoryl halide is 1.75 to 3.5.

In one embodiment, step S1 may include mixing the phosphoryl halide and the fluorine source so that a molar ratio of fluorine to the phosphoryl halide is 1.75 to 2.5.

In one embodiment, step S2 may include mixing the reaction product in step S1, the lithium source and the oxygen source so that a molar ratio of each of lithium and oxygen to the reaction product in step S1 is 0.75 to 1.25.

In one embodiment, in step S2, AX (wherein, A is H, Na, K or NH₄, and X is Cl, Br or I) may be generated.

In one embodiment, step S1 may be performed at 15 to 35° C.

In one embodiment, step S2 may be performed at 40 to 70° C.

According to exemplary embodiments of the present invention, it is possible to produce lithium difluorophosphate with high yield and high purity.

### BRIEF DESCRIPTION OF THE DRAWINGS

FIG. 1 is a flowchart briefly illustrating a method for producing lithium difluorophosphate according to exemplary embodiments of the present invention.

FIG. 2 is FT-IR analysis spectra obtained by analyzing lithium difluorophosphates of an example and Comparative Examples 1 to 3.

FIGS. 3 and 4 are ³¹P-NMR analysis spectra obtained by analyzing the lithium difluorophosphates of the example and Comparative Example 3, respectively.

FIGS. 5 and 6 are ¹⁹F-NMR analysis spectra obtained by analyzing the lithium difluorophosphates of the example and Comparative Example 3, respectively.

FIG. 7 is an analysis spectrum obtained by analyzing the precipitate after capturing a reaction byproduct gas of Example 1 with NH₄OH and precipitating the same by means of FT-IR.

### DETAILED DESCRIPTION

According to exemplary embodiments of the present invention, there is provided a method capable of producing lithium difluorophosphate (LiPO₂F₂) with high yield and high purity by adjusting a moisture content of a reaction system to be low.

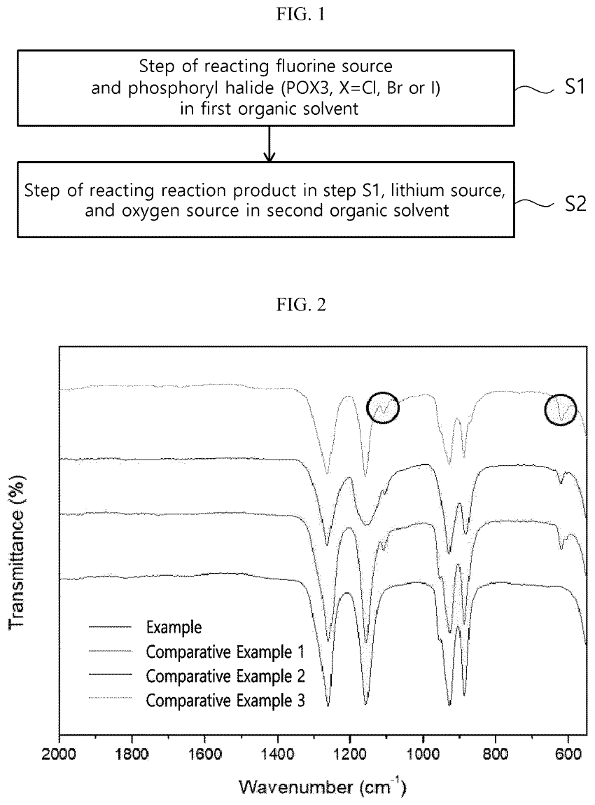

FIG. 1 is a flowchart briefly illustrating a method for producing lithium difluorophosphate according to exemplary embodiments of the present invention.

Referring to FIG. 1, a fluorine source and a phosphoryl halide may be reacted in a first organic solvent (e.g., S1). The phosphoryl halide may be represented by Formula 1 below.

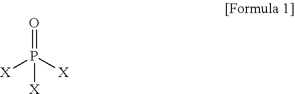

In Formula 1, X may be Cl, Br or I. In some embodiments, X may be Cl.

For example, in step S1, the fluorine source, the phosphoryl halide and the first organic solvent may be mixed to prepare a first mixture.

For example, in the first mixture, the fluorine source and the phosphoryl halide may be reacted to form an intermediate product (hereinafter, the reaction product in step S1) in which halogen in the phosphoryl halide is substituted with fluorine.

In one embodiment, in step S1, the reaction may be performed at 15 to 35° C. In addition, the reaction may be performed for 6 to 12 hours.

In one embodiment, the moisture content in a total weight of the fluorine source may be less than 1,000 ppm. For example, the moisture content may be measured by the Karl Fischer coulometric method.

In some embodiments, the moisture content in the total weight of the fluorine source may be 500 ppm or less, preferably 250 ppm or less, and more preferably 100 ppm or less (substantially anhydrous).

In some embodiments, the moisture content in the first mixture may be less than 1,000 ppm, preferably 500 ppm or less, more preferably 250 ppm or less, and particularly preferably 100 ppm or less. In this case, the reaction system in step S1 may be substantially anhydrous. Accordingly, it is difficult for moisture to substantially participate in the reaction of step S1, such that a generation of impurities due to the moisture may be prevented.

In one embodiment, the fluorine source may include hydrogen fluoride (HF), sodium fluoride (NaF), potassium fluoride (KF), ammonium fluoride (NH₄F) and the like.

In some embodiments, the fluorine source may not include LiPF₆.

Accordingly, manufacturing costs of lithium difluorophosphate may be reduced.

Referring to FIG. 1, the reaction product in step S1, the lithium source, and the oxygen source may be reacted in a second organic solvent (e.g., S2).

For example, in step S2, the reaction product in step S1, the lithium source, and the oxygen source may be mixed to prepare a second mixture.

For example, in the second mixture, the reaction product in step S1, the lithium source and the oxygen source may be reacted to produce lithium difluorophosphate.

In one embodiment, in step S2, the reaction may be performed at 40 to 70° C.

In some embodiments, in step S2, the reaction may be performed at 40 to 55° C.

In one embodiment, in the S2 step, the reaction may be performed for 1 to 12 hours, 3 to 12 hours, or 6 to 12 hours.

In some embodiments, in the S2 step, the reaction may be performed at 15 to 35° C. for 3 to 6 hours, and then performed at 40 to 70° C. (or 40 to 55° C.) for 6 to 12 hours. In this case, the yield and purity of lithium difluorophosphate may be improved.

In one embodiment, the moisture content in the total weight of the lithium source may be less than 1,000 ppm, and preferably 700 ppm or less.

In one embodiment, the moisture content in the total weight of the oxygen source may be less than 1,000 ppm, and preferably 700 ppm or less.

In some embodiments, the moisture content in the second mixture may be less than 1,000 ppm, preferably 700 ppm or less, more preferably 350 ppm or less, and particularly preferably 100 ppm or less. In this case, the reaction system in S2 step may be substantially anhydrous. Accordingly, it is difficult for moisture to substantially participate in the reaction of step S2, such that a generation of impurities due to the moisture may be prevented.

In one embodiment, the lithium source may include lithium chloride (LiCl), etc., and the oxygen source may include O₂ gas, etc.

In some embodiments, lithium hydroxide (LiOH) or lithium carbonate (Li₂CO₃) may be used as the lithium source and the oxygen source. The lithium hydroxide and lithium carbonate may function as the lithium source and the oxygen source, thereby simplifying the process.

In some embodiments, lithium hydroxide may be used as the lithium source and the oxygen source. In this case, LiF, which is generated as a byproduct when using lithium carbonate, may not be generated. Accordingly, the yield and purity of lithium difluorophosphate may be further improved.

In one embodiment, the first organic solvent and the second organic solvent may be the same as each other, or may be different from each other.

In one embodiment, each of the first organic solvent and the second organic solvent may include ethers such as dimethyl ether, diethyl ether, diisopropyl ether, etc.; esters such as methyl acetate, ethyl acetate, propyl acetate, butyl acetate, etc.; nitriles such as acetonitrile, propionitrile, butyronitrile, etc.; hydrocarbons such as pentane, hexane, heptane, etc.; alcohols such as methanol, ethanol, propanol, butanol, etc.; ketones such as acetone, methyl ethyl ketone, etc.; dichlorides such as ethylene dichloride, etc.; carbonates such as dimethyl carbonate, diethyl carbonate, etc.

In some embodiments, each of the first organic solvent and the second organic solvent may be a polar aprotic organic solvent.

In some embodiments, the first organic solvent and the second organic solvent may have a dielectric constant of 5 or more.

In some embodiments, each of the first organic solvent and the second organic solvent may include ethyl acetate (EA), ethylene dichloride (EDC), dimethyl ether (DME) and the like.

In some embodiments, the first organic solvent and the second organic solvent may be the same as each other, and steps S1 and S2 may be performed in-situ (i.e., one pot synthesis).

In one embodiment, in step S1, the phosphoryl halide and the fluorine source may be mixed so that a molar ratio of fluorine to the phosphoryl halide is 1.75 to 3.5. For example, if the number of fluorine atoms (moles) in the fluorine source is n, and a mixing molar ratio of the phosphoryl halide and the fluorine source is a:b, a:n×b may be 1:1.75 to 1:3.5.

In one embodiment, in step S2, the reaction product in step S1, the lithium source and the oxygen source may be mixed so that the molar ratio of each of lithium and oxygen to the reaction product in step S1 is 0.75 to 2. In some embodiments, the molar ratio may be 0.75 to 1.75, 0.75 to 1.5, or 0.9 to 1.2.

For example, when mixing the phosphoryl halide and the fluorine source so that the molar ratio of fluorine to the phosphoryl halide is 3 or more, all of halogens in the phosphoryl halide may be substituted with fluorine. For example, the reaction may be performed as in Scheme 1 below. For the convenience of description, Scheme 1 below shows the case, where AF (wherein, A is H, Na, K, NH₄, etc.) is used as the fluorine source and lithium hydroxide (LiOH) is used as the lithium and oxygen sources, as an example.

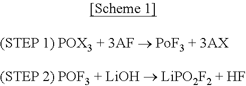

In Scheme 1, A may be H, Na, K or NH₄, and X may be Cl, Br or I.

In some embodiments, in step S1, the phosphoryl halide and the fluorine source may be mixed so that the molar ratio of fluorine to the phosphoryl halide is 1.75 or more and less than 3, preferably 1.75 to 2.5, more preferably 1.9 to 2.5, and particularly preferably 2 to 2.25.

For example, when the molar ratio of fluorine to the phosphoryl halide is within the above range, the reaction may be performed as in Scheme 2 below. For the convenience of description, Scheme 2 below shows the case, where AF (wherein, A is H, Na, K, NH₄, etc.) is used as the fluorine source and lithium hydroxide (LiOH) is used as the lithium and oxygen sources, as an example. In this case, in STEP 2, the reaction may be performed under milder condition than Scheme 1, such that a generation of impurities due to a side reaction may be suppressed. In addition, in STEP 2, particularly toxic fluorine-based byproducts (e.g., HF, etc.) may not be generated.

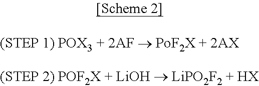

In Scheme 2, A may be H, Na, K or NH₄, and X may be Cl, Br or I.

Hereinafter, preferred example and comparative examples of the present invention will be described. However, the following examples are only preferred embodiments of the present invention, and the present invention is not limited to the following examples.

### Example

A reactor equipped with a stirring device, condenser, and thermometer was prepared.

80.02 g (4 mol) of anhydrous HF (Sigma Aldrich, ACS reagent 48%) was dissolved in 1,000 ml of ethylene acetate (EA), thus to prepare an HF solution.

After adjusting the temperature of the reactor to 5° C., the HF solution and 306.66 g (2 mol) of POCl₃ were put into the reactor and mixed. After setting the temperature of the reactor to room temperature, a reaction was performed for 8 hours.

84.79 g (2 mol) of LiOH (Sigma Aldrich) was additionally put into the reactor and the reaction was performed for 4 hours. Thereafter, the temperature of the reactor was set to 50° C., and the reaction was performed for 8 hours.

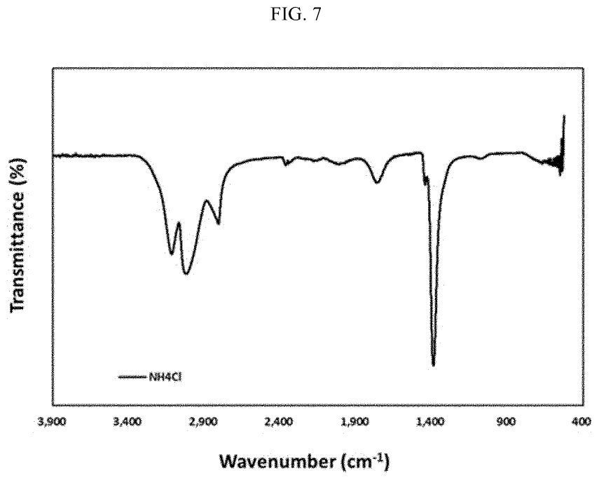

The reaction by-product gas was captured as NH₄OH and precipitated, and then the precipitate was analyzed by means of FT-IR. Referring to FIG. 7, the precipitate was confirmed to be NH₄Cl, and from this, it can be seen that the by-product gas is HCl.

After completion of the reaction, the reaction product was filtered to obtain a solid.

The solid was dissolved in a mixed solvent of dimethyl ether and acetone (5:5 v/v) and filtered. The filtrate was concentrated under reduced pressure and dried in a vacuum oven for 12 hours to obtain a white powder.

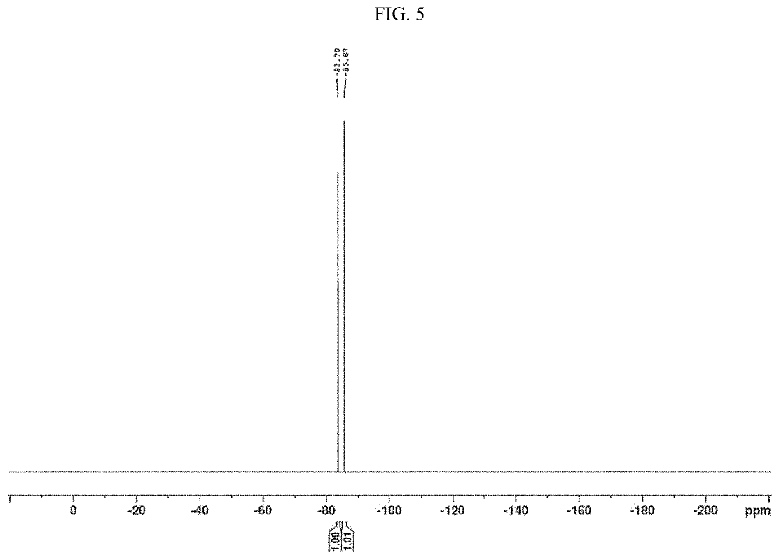

The white powder was analyzed by NMR to confirm that lithium difluorophosphate was produced (see FIG. 5, peaks observed at about 83 ppm and about 85 ppm).

### Comparative Examples

Lithium difluorophosphate was prepared by the same procedures as in Example 1, except that 50% HF and/or LiOH·H₂O were/was used as shown in Table 1 below.

The reaction molar ratio of POCl₃, fluorine and LiOH was maintained the same as in Example 1.

### Experimental Example 1: Measurement of Moisture Content

The moisture content of HF and LiOH used in the example and comparative examples was confirmed using a Karl Fischer moisture measuring device (Metrohm 917 Coulometer).

The moisture content was measured according to the Karl Fischer titration method (coulometric titration method) using 1 g of HF and LiOH, respectively.

TABLE 1

| | HF | LiOH |
|---|---|---|
| Example | About 100 ppm | About 700 ppm |
| Comparative Example 1 | About 100 ppm | About 22,000 ppm |
| Comparative Example 2 | About 5 × 10⁵ ppm | About 700 ppm |
| Comparative Example 3 | About 5 × 10⁵ ppm | About 22,000 ppm |

### Experimental Example 2: Evaluation of Impurity

The lithium difluorophosphates prepared in the example and comparative examples were analyzed by Fourier transform infrared (FT-IR) spectroscopy. The FT-IR analysis spectrum is illustrated in FIG. 2.

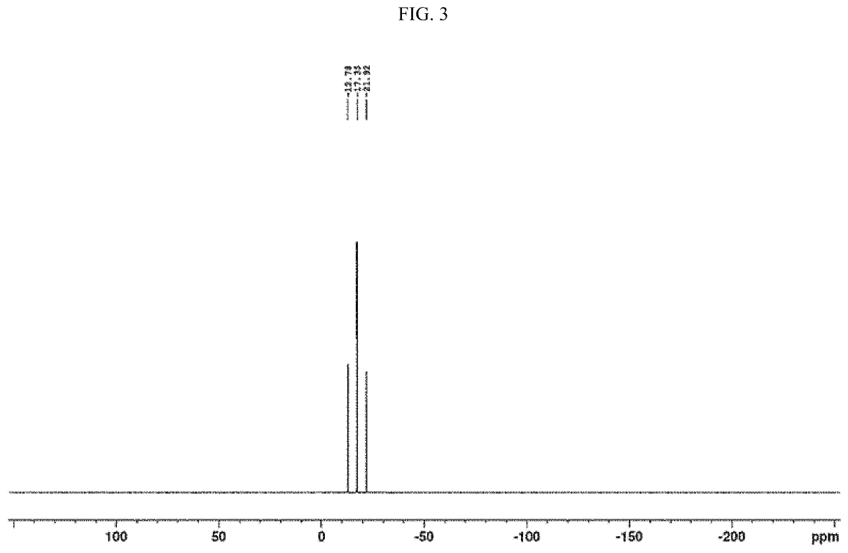

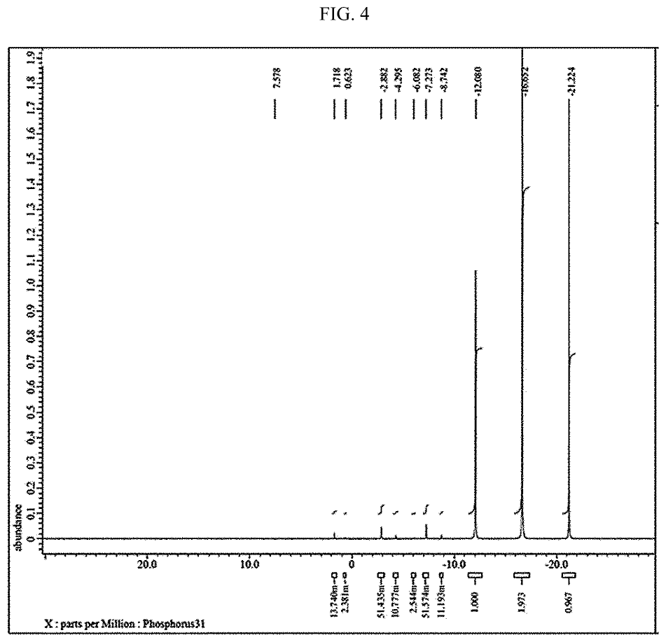

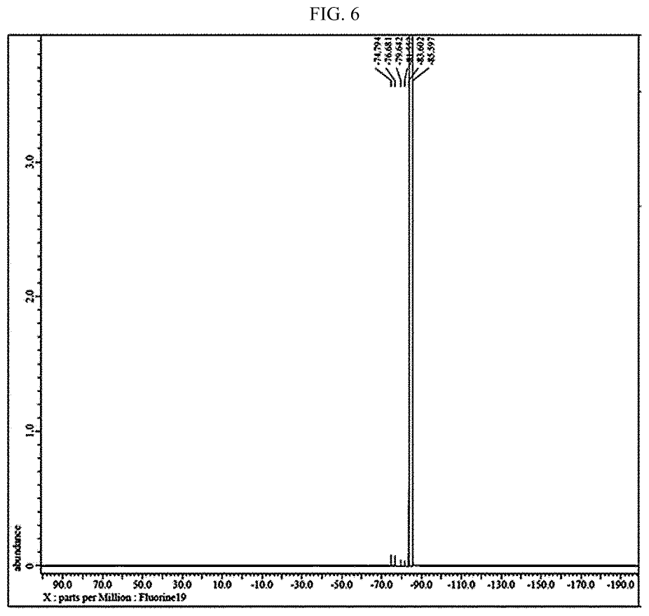

In addition, the lithium difluorophosphates prepared in the example and Comparative Example 3 were analyzed by nuclear magnetic resonance (NMR) spectroscopy. The 31P-NMR analysis spectra obtained by analyzing the lithium difluorophosphates of the example and Comparative Example 3 are illustrated in FIGS. 3 and 4, respectively, and the ¹⁹F-NMR analysis spectra thereof are illustrated in FIGS. 5 and 6, respectively.

Referring to FIG. 2, no impurity peak was observed in the spectrum of the example, whereas impurity peaks (see black circle marks in FIG. 2) were observed in the spectrum of the comparative examples.

Referring to FIGS. 3 and 4, no impurity peak was observed in the spectrum of the example, whereas impurity peak was observed in the spectrum of Comparative Example 3.

Referring to FIGS. 5 and 6, no impurity peak was observed in the spectrum of the example, whereas impurity peaks were observed in the spectrum of Comparative Example 3.

1. A method for producing lithium difluorophosphate, the method comprising:
reacting a fluorine source and a phosphoryl halide represented by Formula 1 in a first organic solvent to obtain a reaction product; and
reacting the reaction product, a lithium source and an oxygen source in a second organic solvent,
wherein each of the fluorine source, the lithium source and the oxygen source has a moisture content of less than 1,000 ppm based on the weight thereof: 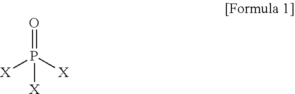
wherein Formula 1, X is Cl, Br or L.

2. The method according to claim 1, wherein the fluorine source has a moisture content of less than 100 ppm based on the weight thereof.

3. The method according to claim 1, wherein each of the lithium source and the oxygen source has a moisture content of less than 700 ppm based on the weight thereof.

4. The method according to claim 1, wherein the fluorine source comprises at least one of hydrogen fluoride (HF), sodium fluoride (NaF), potassium fluoride (KF) and ammonium fluoride (NH₄F).

5. The method according to claim 1, wherein, in Formula 1, X is Cl.

6. The method according to claim 1, wherein lithium hydroxide (LiOH) or lithium carbonate (Li₂CO₃) is used as the lithium source and the oxygen source.

7. The method according to claim 1, wherein each of the first organic solvent and the second organic solvent includes a polar aprotic organic solvent.

8. The method according to claim 1, wherein the first organic solvent and the second organic solvent are the same as each other, and include at least one of ethyl acetate (EA), ethylene dichloride (EDC) and dimethyl ether (DME).

9. The method according to claim 1, wherein the reacting of the fluorine source and the phosphoryl halide comprises mixing the phosphoryl halide and the fluorine source so that a molar ratio of fluorine to the phosphoryl halide is 1.75 to 3.5.

10. The method according to claim 1, wherein the reacting of the fluorine source and the phosphoryl halide comprises mixing the phosphoryl halide and the fluorine source so that a molar ratio of fluorine to the phosphoryl halide is 1.75 to 2.5.

11. The method according to claim 1, wherein the reacting of the reaction product, the lithium source and the oxygen source comprises mixing the reaction product, the lithium source and the oxygen source so that a molar ratio of each of lithium and oxygen to the reaction product is 0.75 to 1.25.

12. The method according to claim 1, wherein, in the reacting of the reaction product, the lithium source and the oxygen source, AX is generated, wherein, A is H, Na, K or NH₄, and X is Cl, Br or I.

13. The method according to claim 1, wherein the reacting of the fluorine source and the phosphoryl halide is performed at 15 to 35° C.

14. The method according to claim 1, wherein the reacting of the reaction product, the lithium source and the oxygen source is performed at 40 to 70° C.
